(19) United States
(12) Patent Application Publication
(10) Pub. No.: US 2006/0116095 A1
(43) Pub. Date: Jun. 1, 2006

(54) Method and system for receiving a multi-carrier signal

(76) Inventor: Jukka Henriksson, Espoo (FI)

Correspondence Address: MORGAN & FINNEGAN, L.L.P., 3 WORLD FINANCIAL CENTER, NEW YORK, NY, 10281-2101, US

(21) Appl. No.: 10/517,937

(22) PCT Filed: Jun. 20, 2002
(86) PCT No.: PCT/FI02/00551

§ 371 Date: Dec. 15, 2005

(51) Int. Cl. H04B 1/10

(52) U.S. Cl. 455/223

(57) ABSTRACT

Method and system for reducing impulsive burst noise in less delayed reception in pilot based OFDM systems, especially using DVB-T standard such as Digital Video Broadcasting (DVB) is provided. The method contains following steps: 1) recognition of the impulse position and possibly length in the time domain symbol, 2) blanking of those samples of the symbol where significant amount of impulse noise is present, 3) calculating the first estimate of the received signal from the blanked symbol, 4) deriving correction values for the carrier estimates by applying prior information (pilot carriers), and 5) the corrected estimate of the received symbol is derived by subtracting the correction values of step 4 from the first estimate of carriers derived in step 3. The method and arrangement allow correction of fairly long bursts of impulse noise with minor degradation only. The complexity of the scheme and the additional energy consumption are fairly low. The method provides considerably more effective more simple and less delay in broadcast data reception than previously known solutions in interfered multi-carrier signal reception.

### TECHNICAL FIELD OF THE INVENTION

This invention relates to systems and methods for distributing data over a communication link.

### BACKGROUND OF THE INVENTION

Broadcast has an almost century long tradition in radio. Even with TV, the history goes back to 1930's. Broadcasting has been successful throughout the world in bringing both entertainment and information to mass audiences.

The latest step in broadcasting is the digitalization of both radio and TV. Digital radio has not gained much acceptance on the market. However, many hope that digital TV will bring new benefits and services to the consumer and, as a result, generate new revenue streams for the broadcasting industry. The basic concept of the TV service itself has, however, not changed much. Rather, the TV lives on as before even if it has become digital.

In later half of 1990's we saw the boom of the Internet. A whole set of new services and content became available to the consumers during a short, revolutionary and hype intense period. That period introduced e-commerce,. Internet Service Providers (ISPs), Portals, eyeballs game, dotcom companies and even the new-economy. The developments in both access technologies (e.g. ADSL) and coding technologies (e.g. MPEG-4 streaming) have made it possible to bring rich media content like video content to homes via the Internet. Despite of these technology and market breakthroughs media houses have been reluctant to distribute their content via the Internet due to its “free-of-charge” nature and the direct threat of piracy. Neither has Internet been able to challenge the role of traditional media as the primary advertisement platform despite its great popularity.

Impulsive interference is observed in broadcast to cause difficulties in broadcast reception. This interference may be produced by ignition sparks from vehicles or various household appliances like hair-dryers, vacuum cleaners, drilling machines etc. The cheapest models of these tools often have insufficient interference suppression. Also for the same reason single or even burst of pulses occur while switching on or off any device connected to the power line. These could be electrical heating devices, thyristor dimmers, fluorescent lamps, refrigerators etc. This has to be taken into consideration, especially in indoor reception with a simple omnidirectional aerial. Field strength of a broadcast signal, especially for a portable device situated indoors, can be quite low and further weakened by multipath reception. For fixed reception, insufficient cable shielding within inhouse signal distribution often reduces the benefit of a roof aerial, making the signal reception sensitive to impulsive interference.

One approach in trying to solve the impulsive noise has been based on clipping the impulse bursts. After clipping, the samples are given the value which corresponds to the clipping level amplitude (and keeping the phase). Or the clipped values may be given value zero because these samples are known to be unreliable in any case. An example of the approaches in these lines has been a patent publication EP 1 043 874 A2, incorporated herein as a reference. In this publication, signal levels exceeding certain clipping levels in time domain are detected and those samples are then replaced by zeros. However, this approach leaves the corrupted but unclipped samples untouched which leads to poor signal-to-interference ratio, especially, if the burst power is high. Moreover, the clipping methods leave impulse levels, not detected, untouched which means that their capabilities are limited. Further, the mere blanking of signal makes signal-to-noise ratio poor.

Another known approach in trying to solve the impulsive noise is to blank all the samples that are known to be corrupted, for example, belonging to an interference burst period. The knowledge of impulse position and duration may be based, for example, on monitoring exceeding of certain clipping levels. One such approach is presented in a publication, Sliskovic, M: Signal processing algorithm for OFDM channel with impulse noise. Electronics, Circuits and Systems, 2000. ICECS 2000. The 7th IEEE International Conference on, Volume: 1, 2000, Page(s): 222 -225 vol. 1, incorporated herein as a reference. However, this method is too straightforward, since all burst suspected of interference are totally blanked. The modified signal is very different than the original, because all data values within the interference are blank and have no correspondence between the original values. Thus, the mere blanking of signal makes signal-to-noise ratio poor. In order to make the performance of blanking approach better, one could try to solve an equation giving the samples of the original signal that have been removed. If the noise burst is detected and the corresponding time samples blanked, theoretically it might be possible to use the information that there should be no signal on the empty carriers (in the guard band) to restore the original post-FFT values. Such an approach has been described in the referred IEEE publication. Unfortunately the method described in the reference requires a solution of general complex system equations which is cumbersome and heavy (generalized matrix inversion, where dimension of matrix is several hundreds or even over 1000). This is complex and difficult to solve. Also relying only to the spectrum part in the guard band turns out to be inefficient in systems with thousands of carriers received through a noisy channel such as the OFDM system. The missing samples cannot be reliably solved. Moreover, the receiver is unable to perform the required theoretically complex calculation. In addition, information about guard band is too vulnerable to the noise, and solutions are inaccurate. Therefore, a relatively simple approximate solution for estimate is needed, which can establish the estimate without too severe delay.

Thus, there is a need for a simpler reception with less delay which can withstand a higher level of interference such as the impulse interference and improve data reception quality.

### SUMMARY OF THE INVENTION

Now a method and arrangement has been invented to resist impulse interference in a received multi-carrier signal which is transferred over a communication link.

In accordance with a first aspect of the invention there is provided a method for receiving a multi-carrier signal, the method comprising the steps of: detecting a presence of at least one impulse interference within the signal, blanking samples where significant amount of the impulse noise caused by the at least one impulse interference is present to obtain a signal with blanking, determining an estimate of the signal with blanking, determining carrier correction values, which carrier correction values are based on deviations of certain carrier values compared to prior known information, and the blanking, and influencing the estimate by the carrier correction values to obtain a representation of a desired signal.

In accordance with a second aspect of the invention there is provided a receiver for receiving a multi-carrier signal, the receiver comprising: a first circuitry for detecting a presence of at least one impulse interference within the signal, a second circuitry for blanking samples where significant amount of the impulse noise caused by the at least one impulse interference is present to obtain a signal with blanking, and for determining an estimate of the signal with blanking, a third circuitry for determining carrier correction values, which carrier correction values are based on deviations of certain carrier values compared to prior known information, and the blanking, and a fourth circuitry for influencing the estimate by the carrier correction values to obtain a representation of a desired signal.

In accordance with a third aspect of the invention there is provided a system for receiving a multi-carrier signal, the system comprising: means for detecting a presence of at least one impulse interference within the signal, means for blanking samples where significant amount of the impulse noise caused by the at least one impulse interference is present to obtain a signal with blanking, means for determining an estimate of the signal with blanking, means for determining carrier correction values, which carrier correction values are based on deviations of certain carrier values compared to prior known information, and the blanking, and means for influencing the estimate by the carrier correction values to obtain a representation of a desired signal.

In accordance with a fourth aspect of the invention there is provided a computer program product comprising a program of instructions executable by a computing system for processing a reception of a broadcast multi-carrier'signal, the computer program product comprising: computer program code for causing the system to detect a presence of at least one impulse interference within the signal, computer program code for causing the system to blank samples where significant amount of the impulse noise caused by the at least one impulse interference is present to obtain a signal with blanking, computer program code for causing the system to determine an estimate of the signal with blanking, computer program code causing the system to determine carrier correction values, which carrier correction values are based on deviations of certain carrier values compared to prior known information, and the blanking, and computer program code for causing the system to influence the estimate by the carrier correction values to obtain a representation of a desired signal.

### BRIEF DESCRIPTION OF THE DRAWINGS

The invention will now be described, by way of example only, with reference to the accompanying drawings, in which:

FIG. 1 shows an example of a generation of the transmitted signal in DVB-T,

FIG. 2 shows an example of the frame structure and how pilots are located in DVB-T applicable for an embodiment of the invention,

FIG. 3 shows a general architecture of the system where principles of an embodiment of the invention can be applied,

FIG. 4 illustrates an example of time domain signals in accordance with an embodiment of the invention,

FIG. 5 depicts a functional block diagram for receiving a multi-carrier signal, where impulse interference is reduced in less delayed data reception in accordance with an embodiment of the invention,

FIG. 6 depicts in a form of a flowchart a method for receiving a multi-carrier signal, where impulse interference is reduced in less delayed data reception in accordance with an embodiment of the invention,

FIG. 7 depicts a receiver for receiving a multi-carrier signal, where impulse interference is reduced in less delayed data reception in accordance with an embodiment of the invention,

FIG. 8 shows an example of a result for an OFDM signal with 2048 carriers, where a less delayed impulse interference reduction is demonstrated in accordance with a further embodiment of the invention,

FIG. 9 shows an example of mean square errors for carriers from 0 to 500, where a less delayed impulse interference reduction is demonstrated in accordance with a further embodiment of the invention.

### DETAILED DESCRIPTION OF THE EMBODIMENTS

Preferable embodiments of the invention provide a method for reducing impulsive burst noise in less delayed reception, for example, in pilot based OFDM systems.

Some methods of the preferable embodiments contain following steps: 1) recognition of the impulse position and possibly length in the time domain symbol, 2) blanking of those samples of the symbol where significant amount of impulse noise is present, 3) calculating the first estimate of the received signal from the blanked symbol, 4) deriving correction values for the carrier estimates by applying prior information (such as pilot carriers), and 5) the corrected estimate of the received symbol is derived by subtracting the correction values of step 4 from the first estimate of carriers derived in step 3. Advantageously, the method and arrangement allow correction of fairly long bursts of impulse noise with minor degradation only. The complexity of the scheme and the additional energy consumption are fairly low. The method provides considerably more effective, more simple and less delay in broadcast data reception than previously known solutions in interfered multi-carrier signal reception.

Some embodiments of the invention are principally based on deriving minimum mean square estimate for the post-Fast Fourier Transformation (FFT) carrier correction values based on the observed deviations from the known pilot carrier values. It turns out that this approach improves the post detection mean square error (MSE) even by some ten to twenty decibels as compared to the mere blanking approach only. The blanking of the time domain samples causes inevitably some degradation as the useful signal power decreases but the embodiments help to avoid much of the additional distortion due to the distorted signal. In otherwise reasonable conditions (reasonable carrier-to-noise ratio, not too fast fading) blanking interval lengths at least of the order of 100 samples (about 10 ms) in 2k systems and 500 samples (about 50 ms) in 8k systems can be tolerated. Moreover, blanking lengths exceeding the above figures can be tolerated, the actual maximum lengths depending on the robustness of the selected transmission mode because the remaining MSE will increase in relation to the blanking interval length.

Advantageously, fairly long bursts of impulse noise can be tolerated as compared to the state of the art. The available length of the correction intervals are adequate for many scenarios. The elimination of the bursts is insensitive to the burst strengths, and the corrected bursts length can be as high as several tens or even hundreds of samples. The burst power may exceed the instantaneous signal power by tens of decibels. While the impulse burst(s) is corrected, the degradation on the overall performance is quite minor compared to the original transmitted signal without the interference(s). If no impulse noise is present, there is very small to no degradation. The method is reasonably robust, channel noise is not expected to degrade the performance very sharply. The method is easily applicable. The receiver detects the impulse. The receiver may determine where the impulse is located. In one simple approach not even the impulse length is needed. The applied algorithm has practically no variances due to different burst noise scenarios. Required changes to existing chip design are minor and can be fairly easily implemented rendering the invention flexible to implement. Some extra control and some calculations are required. The type of calculations are such that similar ones are already existing (channel estimation) on the decoding chip. Therefore, it may be possible to reuse some of those or (at the minimum) similar processing blocks can be repeated in the design. The required additional processing time can be fairly small. Therefore, there occurs less delay in the reception. In addition, only forward type calculations (no feedback) are required which may help in keeping the time budget of the chip processing. The additional energy required for calculations is quite reasonable and poses no major obstacle for the receiver device, and the impulse noise correction is only needed when an impulse is present. The present invention does not require Inversion Fast Fourier Transform (IFFT) nor any kind of feedback (circuitry) but performs the correction of the estimated signal in a straightforward manner. Therefore, the present invention enables less delayed broadcast data reception which is very desirable because of the stream nature of the broadcast transmission. Actually, only one direct FFT is required.

Digital Video Broadcasting (DVB) offers a high bandwidth transmission channel wherein delivery is typically broadcast, multicast or alternatively unicast. The high bandwidth transmission channel can offer a user of such system various services. Proper receiving of the transmitted broadcast data is necessary to focus on the services. A Terrestrial Digital Video Broadcasting (DVB-T) uses Orthogonal Frequency Division Multiplexing (OFDM) in signal transmission and DVB-T is preferably applied in an embodiment of the invention. Alternatively, the invention is also applicable in other OFDM systems, for example transmissions according to Terrestrial Integrated Services Digital Broadcasting (ISDB-T, Japanese standard for digital television, terrestrial), because these kinds of systems provide and use prior known information such as pilot values and may also have empty carriers or other constant carriers within the signal bandwidth.

The digital broadcast transmission provides a receiver device with huge amount of data information. The receiver device should be able to substantially receive data of the service. A nature of the digital broadcast transmission is that the transmission is a streaming distribution typically to multiple receivers applying broadcast or multicast, or alternatively unicast point-to-point distribution to a single receiver. A data distribution link of the broadcast delivery can be a wireless link, a fixed link, or a wired link. For example, DVB-MHP (Multimedia Home Platform) provides the receiver with multiple data distribution links. The digital broadcast transmission system(s) may have an interaction with the receiver but the interaction is not a mandatory requirement. The system(s) with the interaction can request data having errors to be retransmitted but the broadcast reception (having the stream delivery nature) should be able to tolerate errors in data distribution. Therefore, the reception of the digital transmission should be reliable and tolerate, for example, the impulse interference. Moreover, the stream nature of the broadcast transmission poses limits for delays in broadcast data reception. Straightforward simplicity in the receiver device is desirable because of the less delay, construction and power consumption.

Some embodiments of the applied signal in the invention are based on the methods and system presented in a specification EN 301 701 V1.1.1 (2000-08) Digital Video Broadcasting (DVB); OFDM modulation for microwave digital terrestrial television, incorporated herein as a reference.

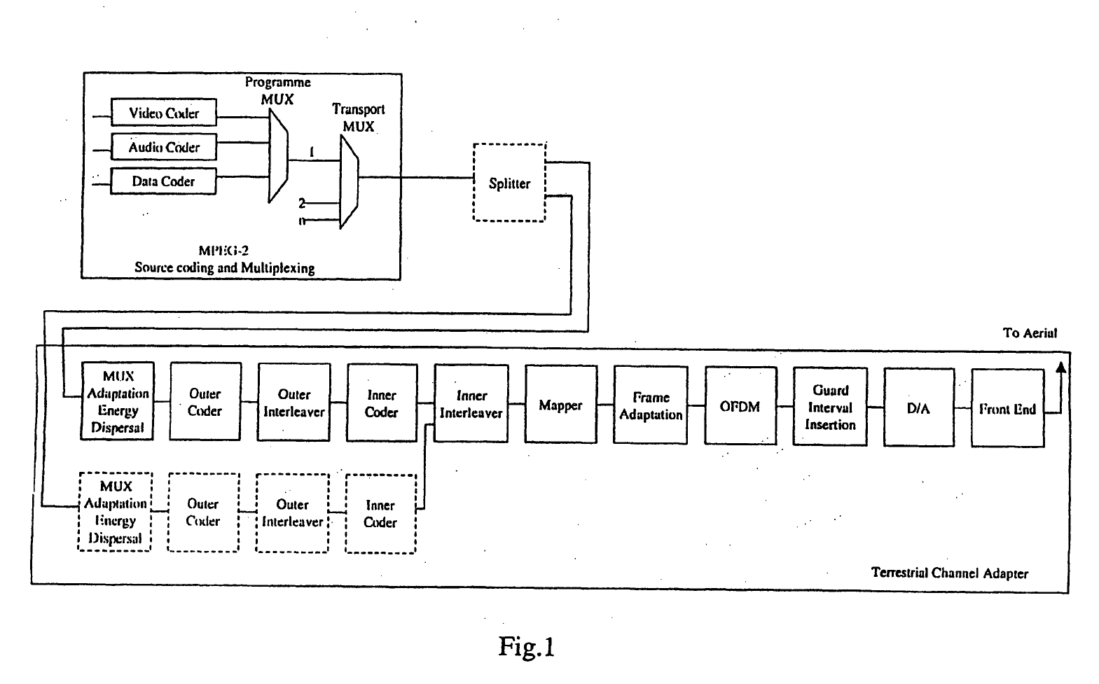

Some embodiments of the invention apply a generation of the transmission signal in DVB-T. These kinds of solutions are presented in a publication EN 300 744 V1.4.1 (2001-01) Digital Video Broadcasting (DVB); Framing structure, channel coding and modulation for digital terrestrial television, incorporated herein as a reference. FIG. 1 shows an example of a generation of the transmitted signal in DVB-T, which is described in chapter 4.1 of EN 300 744. Two modes of operation are defined: a “2K mode” and an “8K mode”. The “2K mode” is suitable for single transmitter operation and for small Single Frequency Networks (SFN) with limited transmitter distance. The “8K mode” can be used both for single transmitter operation and for small and large SFN networks.

Some embodiments of the invention apply prior known information distributed within the transmission signal. These kinds of solutions are presented in the publication EN 300 744 in chapter 4.5.3.

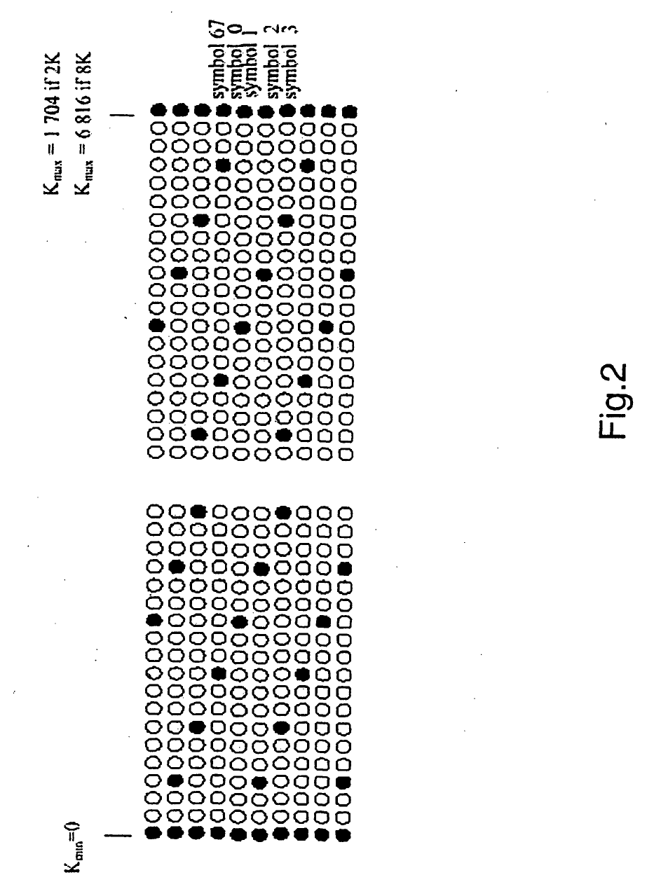

FIG. 2 shows an example of the frame structure and how pilots are located in DVB-T in accordance with a further embodiment of the invention. Reference information, taken from the reference sequence, is transmitted in scatter pilot cells in every symbol. Scattered pilot cells are always transmitted at the “boosted” power level. The pilot insertion pattern is shown in FIG. 2. In FIG. 2 black dots represent boosted pilot and circles without black interior represent data information. Advantageously, the boosted pilots can be applied as prior reference information in determining a correction value for an estimate for the data values corrupted by the impulse interference. Alternatively, an interpolation of OFDM symbols of future or previous pilot values can be applied as prior known information. In this embodiment, the receiver devices computes the interpolations, and the interpolations can be applied as the prior reference information.

Some embodiments of the invention apply the sample. The sample represents time discrete values of the received (multi-carrier) signal taken at intervals of elementary duration. For example, in DVB-T 7/64 μs for 8 MHz channel.

Some embodiments of the invention apply the symbol. In DVB, one OFDM symbol contains N samples, where N represents the FFT size. Preferably, the symbol is represented without guard interval.

Some embodiments of the invention are applicable in the DVB-T such as Digital Video Broadcasting (DVB): Framing structure, channel coding and modulation for digital terrestrial television, ETSI EN 300 744.

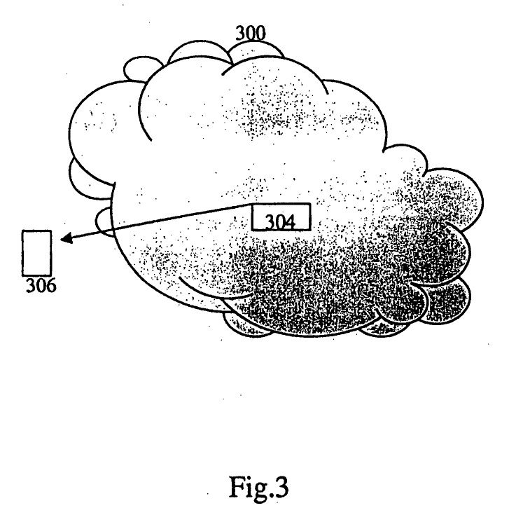

FIG. 3 has been described in the foregoing. In the following, corresponding reference signs have been applied to corresponding parts. Some embodiments of the invention apply the system of FIG. 3. A receiver 306 operates preferably under the coverage of a digital broadcast network (DBN) 300. The receiver 306 is capable of receiving the transmission that the DBN 300 is providing. The transmission of the DBN 300 comprises Transport Stream (TS). The DBN 300 comprises means for modifying the transport stream that it is transmitting. The DBN 300 provides means for generating and transmitting the signal having the prior reference information such as the pilots and data information as described in the example of FIG. 2. The boosted pilot values are included in the OFDM symbol, and therefore applicable. The receiver 306 receives the OFDM symbol transmitted by the DBN 300. The receiver 306 can of course identify data and the prior reference information such as the pilot carrier values. The receiver 306 detects also the impulse interference. Therefore, the receiver 306 can create an estimate for data values representing original signal using both the received signal and the prior reference information such as the pilots. Advantageously, a user of the receiver 306 does not need to give beforehand modifications to such activities, and the receiver 306 can perform the correction continuously and substantially straightforward while receiving the service. Advantageously, the receiver 306 does not require any interaction for correcting the data values representing the original signal. Therefore, the embodied invention is cost efficient.

Still referring to FIG. 3, the digital broadcast network (DBN) 300 transfers the data to the user over a data/communication link. Examples of the DBN 300 are a Digital Video Broadcasting (DVB) or alternatively ISDB-T network configured to transfer data information. Advantageously, a terrestrial digital video broadcast (DVB-T) network is applied in the invention. The DBN 300 comprises an ability to transfer data over the data link. Before the transmission, the data is processed in the DBN 300.

As is well known in the art, for example, IP encapsulators 304 perform a multi-protocol encapsulation (MPE) and places the IP data into Moving Picture Experts Group-Transport Stream (MPEG-TS) based data containers. The encapsulators 304 perform the generation of the tables, the linking of the tables and the modification of the tables. Alternatively, a multiplexer of the DBN 300 can perform this.

According to some embodiments, the operation of the IP encapsulators 304 may involve placing the received data into UDP packets, which are encapsulated within IP packets, which are in turn encapsulated into DVB packets. Details of this multi-protocol encapsulation technique may be found, for example, in standard document EN 301 192, incorporated herein as a reference. At the application layer, usable protocols include UHTTP (unidirectional HTTP), RTSP (Real-Time Streaming Protocol), RTP (Real-time Transport Protocol), SAD/SDP (Service Announcement Protocol/Service Description Protocol) and FTP.

In certain further embodiments, IP encapsulation may make use of IPSEC (Internet Protocol Security) to ensure that content will only be usable by receivers with the appropriate credentials. During the encapsulation process, a unique identifier may be added to at least one of the headers. For example, when UHTTP is used, the unique identifier may be encoded in the UHTTP header under the UUID field. Therefore in certain embodiments, to cater for the delivery of data to a particular terminal or group of terminals, the containers may also hold address information which can be identified and read by a conditional access component in the receiver 306 to determine whether the data is intended for that terminal. Alternatively, to cater for the delivery of data to a plurality of terminals multicast can be applied, and advantageously single sender can reach multiple receivers. A Virtual Private Network (VPN) can also be formed in the system of the DBN 300, and the receiver 306. A certain bandwidth of the DBN 300 broadcasting is allocated to a point-to-point or point-to-multipoint communication from the DBN 300 to the receiver 306. The DBN 300 may also have various transmission channels for other streams running. The receiver 306 performs a multi-protocol decapsulation to form the IP data packets.

The DVB packets so produced are transmitted over the DVB data link as is known in the art. The receiver 306 receives digitally broadcast data. The receiver 306 receives the prior reference information, for example, pilot and can correct data values of the signal infected by the impulse interference. The receiver provides more simple broadcast data reception with less delay. Therefore, the receiver 306 can substantially receive the data service, and the user can consume the provided service using the receiver 306. When a transmission rate is specified by the caster, that rate is adhered to.

In the following, theoretical background details are provided for some embodiments of the invention.

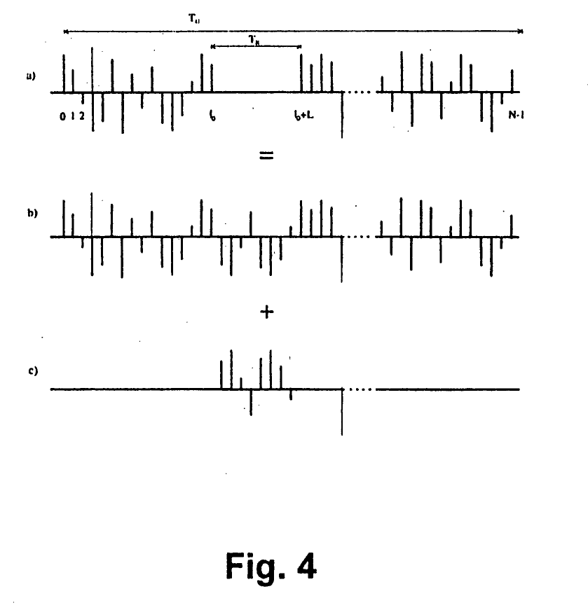

FIG. 4 has been described in the foregoing. In the following, corresponding reference signs have been applied to corresponding parts. An example of FIG. 4 illustrates the creation of the blanked signal as a sum of the original and negation of the blanked samples. One principal idea behind some embodiments is to avoid the harmful effects of impulse noise by deleting at least those samples which are suspected to be substantially corrupted. These samples are replaced by known values such as zeros. Thus, the distortion caused to the signal can be estimated after the receiver FFT relatively reliably as the distortion is of known format and regular. Of course, the deleted samples are not fully known but rather the signal after the blanking can be described as a sum of the wanted (but not reliably known) transmitted signal for the whole symbol time T_{U} and the unwanted part for the blanking time T_{B}. The samples of the time T_{B} are negations of the wanted samples for the same time interval (as illustrated in the example of FIG. 4).

Referring to the example of FIG. 4, the receiver takes FFT of the blanked signal (a). As FFT is a linear operation it can be divided into two parts: sum of the FFTs of the wanted signal (b) and the negation samples (c). As the wanted signal contains known pilot values (which can be estimated based on the earlier and in some cases also later OFDM symbols) the contribution of the blanked samples can be estimated based on the deviations of the pilot values from the expected values without blanking. A theoretically pleasing way of doing this is to estimate the carrier deviations based on minimum mean square error estimation when the pilot value deviations are given. Preferably, a very satisfactory performance can be simply achieved by using only knowledge of the deviation values of the two (or at most four) closest pilots. Alternatively for the best performance, the information of all pilot values can be applied to derive each carrier deviation estimate.

Some embodiments of the invention apply multiple pilots, and theoretical details for those are described below. For the general embodiment for obtaining quite good estimate, one may apply orthogonality principle in deriving the appropriate weights wⱼ by which the pilot deviations pⱼ should be multiplied in order to find the linear MSE estimate bₖ for the carrier deviations (or correction values). The principle can be written as a set of equations:

$$E \{ ( {b}_{k} - {\sum }_{j} {w}_{j} {p}_{j} ) {p}_{l}^{*} \} = 0 ∀ l , l = 0 , m , 2 m … \qquad ( 1 )$$

where k is the carrier index, * denotes complex conjugate and m is the pilot spacing (for DVB-T m is 12 in one OFDM symbol) and E{ } denotes statistical averaging operation. For each carrier index k this may be written as
c_{b}(k,l)=cₚ^{T}(l)w, l=0, m (2)
where c_{b}(k,l) is the covariance of the k^{th} carrier deviation with the pilot deviation with index l. Of course, index l gets values from the set of carrier indexes and thus only every m^{th} value is a valid pilot index. The covariance c_{b}(k,l) is calculated as
c_{b}(k)=E{bₖ·pₗ*}. (3)

Similarly the vector cₚ(l) contains covariances between pilot deviations (superscript T denotes matrix transpose). These vectors have as many elements as there are pilots in the general case. The i^{th} element of vector cₚ(l) is given as
cₚ(l)=cₚ(im−l) (4)
and the covariance cₚ(δ) on the right-hand side is defined as
cₚ(δ)=E{pⱼ·p_{j-δ}* }. (5)

The exemplary formula above assumes that the deviations can be treated as wide sense stationary process (the result of (5) is independent of the pilot index j) which is a reasonable assumption for practical signals.

One may proceed one step further and write equation (2) in matrix notation containing all pilot indexes l=0,m, . . . (M−1)m as
c_{b}(k)=Cₚw (6)
where the number of elements in vectors c_{b} and w is the same as the number of pilots (M).

The left-hand side vector c_{b}(k) is given by

$${\underline{c}}_{b} ( k ) = [ \begin{matrix}{c}_{b} ( k , 0 ) \\ {c}_{b} ( k , m ) \\ {c}_{b} ( k , 2 m ) \\ ⋮ \\ {c}_{b} ( k , ( M - 1 ) m\end{matrix} ] \qquad ( 7 )$$

and the matrix Cₚ is the (M×M) covariance matrix of the pilot deviations given by

$${\underline{\underline{C}}}_{p} = [ \begin{matrix}{c}_{p} ( 0 ) & {c}_{p} ( m ) & {c}_{p} ( 2 m ) & ⋯ & {c}_{p} ( ( M - 1 ) m ) \\ {{c}_{p} ( m )}^{*} & {c}_{p} ( 0 ) & & & \\ {{c}_{p} ( 2 m )}^{*} & & ⋰ & & \\ ⋯ & & & ⋰ & \\ {{c}_{p} ( ( M - 1 ) m )}^{*} & & & & {c}_{p} ( 0 )\end{matrix} ] . \qquad ( 8 )$$

The required weight values w can now be solved formally using matrix inversion as
w=(Cₚ)⁻¹c_{b}(k). (9)

The carrier correction value bₖ for the k^{th} carrier is then estimated as
bₖ=w^{TP,} (10)
where vector P contains the pilot deviation values
P=[p₀pₘ . . . p₍ₘ₋ₗ₎ₘ]^{T}. (11)

These correction values bₖ are subtracted from the carrier values which were resulting from the FFT of the signal samples with blanking.

Some embodiments of the invention apply two pilots, and a theoretical details for those embodiments are described below. For some most simple realizations, the matrix inversion can be in some cases cumbersome as well as also other group equation solving techniques, if a great number of pilots is used. However, very good estimates can be derived even if a very small number of pilots is applied. The simple example of applying only the two closest pilots provides fairly good performance in many systems, especially in DVB-T.

Referring to the simple two pilot embodiments, the k^{th} carrier deviation using only the closest pilots is estimated. That can be done using equations (10) and (9). The weight vector w shall have only two elements w₀ and w₁. The values are calculated using (9). In the following, there is written out the two matrices in the right-hand side of (9).

The index for the pilot carrier below k will be k-mod(k,m), where mod(k,m) means k modulo m. The index for the pilot carrier above will be k-mod(k,m)+m. The Cₚ matrix in (9) will now be a 2×2 matrix as

$${\underline{\underline{C}}}_{p} = [ \begin{matrix}{c}_{p} ( 0 ) & {c}_{p} ( m ) \\ {{c}_{p} ( m )}^{*} & {c}_{p} ( 0 )\end{matrix} ] \qquad ( 12 )$$

which is independent of k. The matrix inversion needed in (9) can be easily calculated in advance for each blanking interval length. The covariance cₚ(m) depends on that length (and shape of the blanking window). The covariance vector c_{b}(k) can be written as

$${\underline{c}}_{b} ( k ) = [ \begin{matrix}{c}_{b} ( k , k - mod ( k , m ) ) \\ {c}_{b} ( k , k - mod ( k , m ) + m )\end{matrix} ] \qquad ( 13 )$$

where only the two closest pilots are used. If there is taken into account the wide sense stationary nature of the deviation process, one may conclude that the covariance functions are only dependent on the difference of the indexes (carrier and pilot). Then (13) simplifies to

$${\underline{c}}_{b} ( k ) = [ \begin{matrix}{c}_{b} ( mod ( k , m ) ) \\ {c}_{b} ( mod ( k , m ) - m )\end{matrix} ] . \qquad ( 14 )$$

Vector c_{b}(k) has only (at most) m−1 possible complex value pairs because pilot values need not be estimated. Otherwise the modulo-operation means that the same set of weights repeats for other pairs of pilot indexes. For example, for DVB-T this means 11 sets of complex value pairs. This is quite reasonable number to have in memory. Due to strong symmetry this value still tends to decrease to be only about half of that upper limit. As signal properties as well as blanking window can be known in advance, the weight vectors w can be calculated for the m−1 carrier indexes and stored into memory.

For the final estimate of carrier correction values bₖ of (10) we also need the pilot vector as

$$\underline{P} = [ \begin{matrix}{p}_{k - mod ( k , m )} \\ {p}_{k - mod ( k , m ) + m}\end{matrix} ] . \qquad ( 15 )$$

Some embodiments of the estimation procedure, which is described above, require knowledge of the covariance values of the deviation process. There are several approaches to obtain them. First, one may derive the theoretical covariance functions taking into account the modulation parameters, window length and shaping, etc. This can be feasible at least if some approximation and simplifying assumptions are made. The next approach is to run computer simulations for the required system parameters and thus obtain reliable estimates for the covariance values. This might give the good results relatively simply. The third approach can be based on measuring some prototype receiver to get the covariance values. The fourth approach is to take some reasonable smooth approximation for the covariance function. Such a sub-optimal approach leads to quite simple realization.

As an illustrative example we derive approximation for the autocorrelation function of deviation process for a DVB-T like signal. We assume, as it is illustrated in DVB-T standard, that the real signal s(t) is given by

$$s ( t ) = Re \{ {ⅇ}^{j {ω}_{c} t} {\sum }_{k = 0}^{N - 1} {c}_{k} {ⅇ}^{j 2 π {k}^{′} \frac{t}{TU}} \} \qquad ( 16 )$$

where ω_{c} is the center angular frequency, k′=k-N/2, cₖ is a complex coefficient at carrier index k representing the modulated bits and T_{U} is the duration of the useful OFDM symbol (without guard interval). N is the FFT size of the used OFDM modulation. For the following we use complex envelope notation and calculate the l^{th} sample taken at intervals T, where T=T_{U}/N as

$${s}_{l} = {\sum }_{k = 0}^{N - 1} {c}_{k} {ⅇ}^{j 2 π {k}^{′} \frac{l}{N}} . \qquad ( 17 )$$

In order to determine the autocorrelation function of the deviation process we first calculate the discrete Fourier transform of samples sₗ over the interval [l₀,l₀+L), (FIG. 4(c)). The value at carrier index r is calculated as

$${b}_{r} = \frac{1}{N} {\sum }_{k = 0}^{N - 1} {c}_{k} {\sum }_{q = {l}_{0}}^{{l}_{o} + L} {ⅇ}^{j 2 π q \frac{{k}^{′} - r}{N}} . \qquad ( 18 )$$

The autocorrelation for carrier deviations can now be derived to be approximately

$$c ( r , s ) = E \{ {b}_{r} {b}_{s}^{*} \} ≡ \frac{1}{{N}^{2}} {\sum }_{k = 0}^{N - 1} E \{ {\vert {c}_{k} \vert}^{2} \} {\sum }_{q = {l}_{0}}^{{l}_{0} + L} {ⅇ}^{j2π q \frac{s - r}{N}} . \qquad ( 19 )$$

In derivation example, it is assumed that the modulation values cₖ are zero mean and statistically independent and that the blanking length L is small, e.g. less than 10%, in relation to the whole symbol period (N samples). Notice also that for DVB-T some of the values cₖ are zero so that effectively the outer summing is from 0 to n-1 where n is the number of active carriers. The autocorrelation of (19) indeed has the desired property that the value of c(r,s) depends only through the difference (s−r) on the index values s and r. Now the required covariances are directly given by the equation above for the noiseless case. If noise is present (and taken into account in the optimal way) slight changes to the pilot covariance matrix Cₚ should be made. The resulting matrix instead of (12) is then written as [exact derivation omitted, simple]

$${C}_{= p} = [ \begin{matrix}{c}_{p} ( 0 ) + {σ}^{2} & {c}_{p} ( m ) \\ {{c}_{p} ( m )}^{*} & {c}_{p} ( 0 ) + {σ}^{2}\end{matrix} ] \qquad ( 20 )$$

where σ² is the noise variance.

Some embodiments of the invention apply sub-optimal approximation. For many practical realizations it is enough to apply a good approximation for the correlation function c(r,s) or c(f). Variable f is here the relative frequency difference (r−s). If the blanking window in the time domain is fairly short (and symmetrical) and is located near the OFDM symbol end, the frequency domain correlation function is quite wide and the function does not change much between 0 and m, where m is the frequency difference between two consecutive pilots (difference of pilot indexes). Moreover, one may assume that the correlation function can be approximated by linear change in the interval [0,m]. The normalized correlation function is of the form

$$c ( f ) = ( \frac{ρ - 1}{m} \vert f \vert + 1 ) {ⅇ}^{j \frac{θ}{m} f} \qquad ( 21 )$$

where ρ is the magnitude of the correlation coefficient at frequency difference m and θ is the corresponding phase. If the center of the blanking window is at zero sample (blanking takes place symmetrically at both ends of the symbol) then θ is zero, otherwise it is a relatively small number. The covariance matrix Cₚ required in calculating the carrier correction values bₖ from (10) is now given by (substituting (21) into (12))

$${C}_{= p} = [ \begin{matrix}1 & ρ {ⅇ}^{j θ} \\ ρ {ⅇ}^{- j θ} & 1\end{matrix} ] \qquad ( 22 )$$

The covariance vector c_{b}(k) can be rewritten (from (14), no thermal noise taken into account) as

$${\underline{c}}_{b} ( k ) = [ \begin{matrix}( \frac{ρ - 1}{m} \vert mod ( k , m ) \vert + 1 ) {ⅇ}^{j \frac{θ}{m} mod ( k , m )} \\ ( \frac{ρ - 1}{m} \vert mod ( k , m ) - m \vert + 1 ) {ⅇ}^{j \frac{θ}{m} [ mod ( k , m ) - m ]}\end{matrix} ] . \qquad ( 23 )$$

Now the weight vector (9) can be rewritten as (using (22) and (23))

$$[ \begin{matrix}{w}_{0} \\ {w}_{1}\end{matrix} ] = [ \begin{matrix}{ⅇ}^{j θ \frac{mod ( k , m )}{m} ( 1 - \frac{mod ( k , m )}{m} )} \\ \frac{mod ( k , m )}{m} {ⅇ}^{- jθ + jθ \frac{mod ( k , m )}{m}}\end{matrix} ] . \qquad ( 24 )$$

The result is simple and it has the advantageous property that the actual correlation value ρ has been cancelled out. Thus, the weighting (24) is robust and valid under quite general assumptions. Principally it only requires that the blanking window is short (and symmetrical) as compared to the total OFDM symbol length and substantially near symbol end. For some embodiments, this brings the advantageous property that the receiver does not need to adjust the weights according to the blanking length—only the location (center point) of the window is needed.

The value θ depends on the location of the blanking window. If the receiver shifts the input sample vector after blanking so that the blanking window is symmetrically located in the beginning and at the end of the resulting vector (i.e. blanking window center point to zero), the, value θ would become zero. That further simplifies calculations in (24) and leads to a desirable implementation in some embodiments. However, this sub-optimal approach also requires that the corrected carrier values are once more corrected by the linear phase shift caused by the sample shift in the time domain. It depends on the actual chip architecture whether this sub-optimal approach is feasible, or would the method requiring somewhat more knowledge about correlation function (using equations (12) and (14)) be more appropriate.

If there is a need to avoid shifting the samples in the time domain, the same effect can be achieved by phase correction in the frequency domain. The correlation function of (21) changes to the form

$$c ( f ) = ( \frac{ρ - 1}{m} \vert f \vert + 1 ) {ⅇ}^{j \frac{θ}{m} f} \cdot {ⅇ}^{j 2 π f \frac{i}{N}} \qquad ( 25 )$$

where i is the window position shift (in number of samples) in the time domain. The following formulas (22)-(24) change accordingly.

Instead of (21) the actual correlation function corresponding to the blanking window in zero position can be applied (or near zero end), and make the phase correction according to actual window position like in (25). Advantageously, the blanking window lengths can be quite long (for example, about 100 in 2k system), and thus, only a relatively small number of blanking window positions are processed (for example, order of 20-30 in 2k DVB-T). For a system with pilot spacing m, there are roughly m/2 phase correction values to be calculated for each window position (the rest is simply related). Taking into account that half of the window positions can also be handled with simple relations, it turns out that only about Bm/4 complex phase correction values are to be stored (or fully calculated), where B is the number of blanking windows needed to cover the whole OFDM symbol. For 2k DVB-T with the previous numbers, this is about 60 complex numbers, which advantageously is reasonably low amount (and by proper choice of parameters part of these values overlap, which reduces the required memory/process power still further).

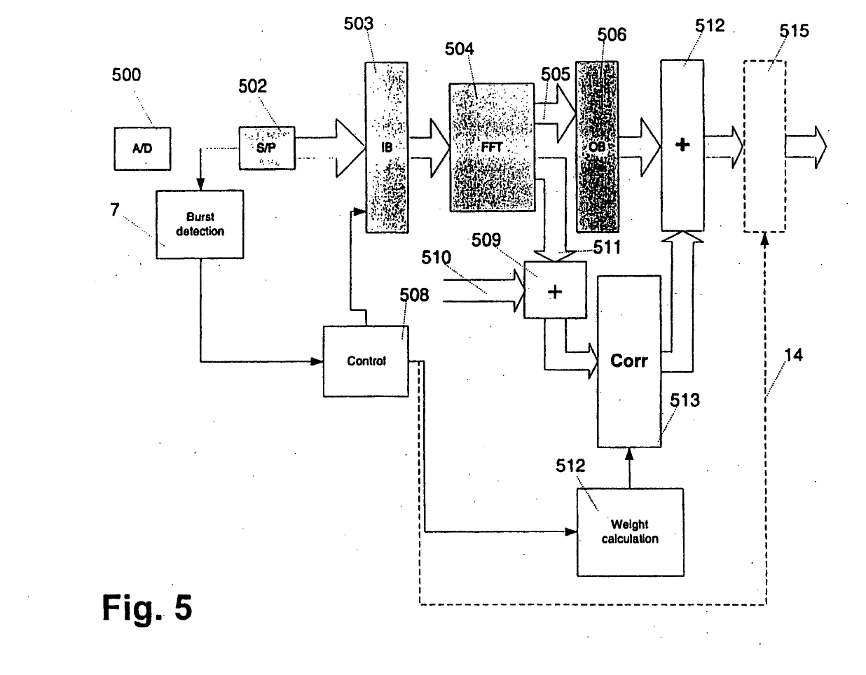

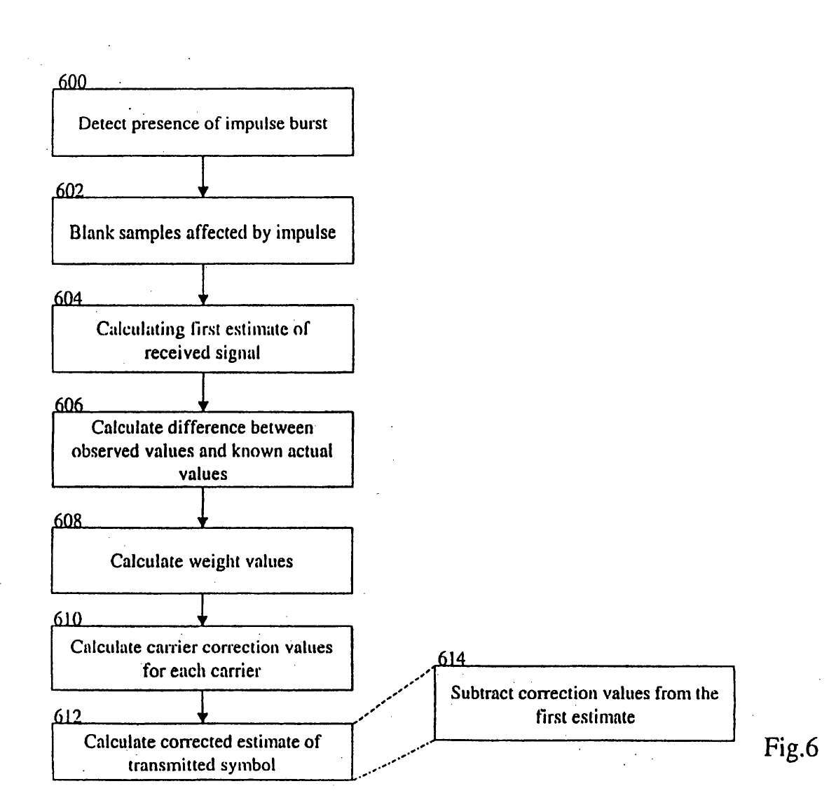

FIGS. 5 and 6 have been described in the foregoing. In the following, corresponding reference signs have been applied to corresponding parts. Examples of FIGS. 5 and 6 reduces and tolerates impulsive burst noise in less delayed manner in pilot based OFDM systems, especially using DVB-T standards. The example of FIGS. 5 and 6 apply the two closest pilots in estimating the carrier correction values. A received signal is analog to digital (A/D) converted (block 500) and samples of the received signal is processed. There could be IQ-split in any convenient phase either before A/D or after. The examples of FIGS. 5 and 6 assumes complex signal notation everywhere and is general in that sense. Preferably, the practical implementations apply real and imaginary parts separately.

In step 600, there is detected the presence of the impulse noise. This may comprise a detection of a level or a power of the impulse. The burst noise detection can be based on the sliding window calculation method, where the power of a number of samples is calculated. The number should be relatively small, maybe between 5 and 15 (8 samples is roughly 1 μs in DVB-T). If difference to a reference value is greater than a threshold, a presence of the impulse noise is decided. Other methods can be used as well.

In step 602, the samples affected by the impulse is blanked. Preferably, the length of this blanking interval should be equal to the impulse burst length provided that maximum length for restoration is not exceeded. One could also use a selection of predetermined blanking lengths, in further embodiments only one length. Preferably, the constant certain length window which only takes different places leads to one of the simples implementation. The blanking can take place before serial-to-parallel conversion (block 502). Preferably, the blanking is performed in an input buffer (IB) (block 503) controlled by a control device (block 508). The control device (block 508) keeps also record on the corrupted sample indexes. The blanking window can be a simple rectangular window. Alternatively, the blanking window may have some shaping like linear or raised cosine ending transitions.

In step 604 there is calculated a first estimate of the received signal. A Fast Fourier Transformation (FFT) (block 504) of the signal with the blanking(s) is calculated and forwarded (block 505), and the result of the calculation is saved in the output buffer (OB) (block 506). At this phase the first distorted estimate of the transmitted signal is obtained. Due to blanking, some distortion will be present. The values of the pilot carriers are not those which were transmitted but distorted. However, the correct pilot values are known provided that any previous symbol was correctly received (in the channel estimation sense), and that the channel has not changed too much from symbol to symbol so that a first estimate of the channel state can be fairly reliably made based on the history. This is very valid assumption for fixed and portable reception and can be valid also for mobile scenarios. The known pilot values may also be a result of a more complicated time domain interpolation (pilot values gathered from several sequential OFDM symbols).

In step 606 a difference between the observed and the known actual values are calculated. The difference is calculated in a summing device (block 509) between the observed pilot values (block 511) and the known actual values for pilot carriers (block 510). For pilots these known values are transmitted pilot values multiplied with the channel estimate on pilot frequencies.

In step 608 weight values (w) are calculated. The weight values (w) corresponding to the blanking window position, length and applied modulation (for example, equation (9) in the general embodiment) is calculated in block (block 512). The information about the location of the blanking window is derived from the control unit (block 508). Preferably, two pilots per one carrier value estimation are applied. One of the simplest embodiment can apply the phase corrected appliance of the equation (24) to determine the weights (w), and the window length nor the modulation parameters do not have to be known. The weight values (w) may be calculated in advance and read from memory. Advantageously, the same set of weight values (w) is repeatedly applied between consequential pilot pairs and, hence, the required memory is fairly small.

In step 610, carrier correction values for each carrier is calculated. The required carrier correction values (bₖ) for each carrier (except possibly, for pilots) are calculated in block (513). The calculation applies equations (10) and (15).

In step 612, corrected estimate of transmitted symbol is calculated. The corrected estimate of the transmitted symbol is calculated by subtracting (block 512) the correction values from the estimates generated in the step 404, which are stored in the output buffer (OB) (block 506). The corrected carrier values are forwarded for appliance(s). Therefore, the data service can be substantially received tolerating the interferences.

An alternative embodiment in FIG. 5 contains a dashed line block (block 515). In the alternative embodiment, the input samples are shifted (rotated) in the input buffer (IB) (block 503) in such a way that the blanking window is always centred at zero samples. The weight calculation (block 512) is always the same, which is simple and therefore beneficial. In addition, the receiver has to compensate the phase shift (in block 515) for each carrier depending on the actual blanking window shift. The alternative embodiment sets substantially the same level of complexity.

Some embodiments of the FIG. 5 blocks can be substantially divided into four parts: detection of burst (position and alternatively also length), blanking and FFT of blanked samples, estimation of carrier correction values and correction of the first estimate of the received symbol.

Some embodiments of the invention apply the detection of burst. For burst detection there are several possibilities (some known earlier from literature). Preferred method is using the sliding window approach where the instantaneous received power is monitored and compared to some reference value. This reference could, for example, be the mean power of the previous symbol (the signal level remains substantially at the same level that the measurement could be reasonably reliable—at least for fixed or portable reception). The reference could also be some earlier, delayed value of the sliding window power calculation. Other possible means for burst detection are monitoring the exceeding of some threshold level in amplitude. Also while applying this method the window approach can be useful. The decision criterion can be having a certain number of level crossings during the window, and all the samples belonging to window can be marked “under burst”. Still another approach can be monitoring amplitude variations. One could calculate the difference of two successive samples, take the absolute value and compare to a threshold. Again, the window approach is also in this method useful, and one can decide the presence of the burst if number of variations exceeding the threshold value exceeds some limit number. There are also other possible approaches, for example, combinations of the above ones.

Some embodiments of the invention apply the blanking. For blanking appliance there are also several possibilities. One simple one is using only the burst position information and constant blanking duration. Moreover, the blanking window positions could be taken from a limited, predetermined set. The positions are selected so that the blanking intervals overlap partly, and the bursts at any position can be handled at least provided that they are shorter than the overlapping part length. The limited selection of blanking window positions helps to reduce the required memory in weight calculations. A more sophisticated and efficient way of handling blanking is based using both position and duration information. Those samples, which belong to the detection window fulfilling the burst criterion, would be blanked. The weight calculation applies now information on blanking window location as well as its length. For many possibilities the weights are calculated by a program each time they are needed. The shape of the blanking window can be a simple rectangular one. Alternatively, shaped blanking windows with smooth transitions at the end can be applied. The distortion caused by such windowing is smaller and can be beneficial in some implementations.

Some embodiments of the invention apply the estimation of the carrier correction values. For the estimation of the carrier correction values there are several possible approaches also. One of the most general approach applies all prior known information, i.e., both the pilot values and the guard band values (or at least pilots plus those guard band values which belong to the pilot raster m). Each carrier correction would be calculated using all this available prior information. As described above this may cause some complicated implementation with little value in performance enhancement. Another approach is to apply only the two closest pilots in estimating the carrier value corrections. In this embodiment, there can be applied either the actual covariance function (calculated, simulated or measured; there can be even included a measuring arrangement to derive the covariance function “on fly” but that can establish more complicated approach) or the simplified approach described above, also other approximations could be used than the simple linear one given in this paper. In deriving the covariance function there can be two possible principal lines: 1) Keep the blanking window in its original place and derive the covariance function taking the actual location into account. 2) Take the other approach by shifting/rotating the input samples so that the blanking window is always centred zero (or near it in a fixed place). In the latter embodiment each carrier value requires a separate phase correction (block 515 in the example of FIG. 5) before going further in the receiver.

Some embodiments of the invention apply the correction of the first estimate. For correction of the first estimate there is a principal way of doing it: subtract the estimated correction values from the corresponding first estimates of the carriers. However, depending on whether the input buffer (IB) (503) was rotated or not the corrected carrier values may require phase correction.

Preferred embodiments of the invention are implemented on chip at the receiver device. For example, the invention is included in DVB-T chip at the receiver device. Alternatively, the invention is applicable at an inter-mediator intermediating data traffic in broadcast system, for example, a gateway bridging communication between at least two different network interfaces. Some embodiments of the invention supports portable reception in IP datacast receivers, and can, possibly, work under severe condition. Thus, the performance of the embodiments boosts benefits of the invention such as economy. For example, DVB-T offers an effective and cheap way to distribute data, and the embodiments promote the less delayed and more simple reception for broadcast data stream even under severe or noisy conditions.

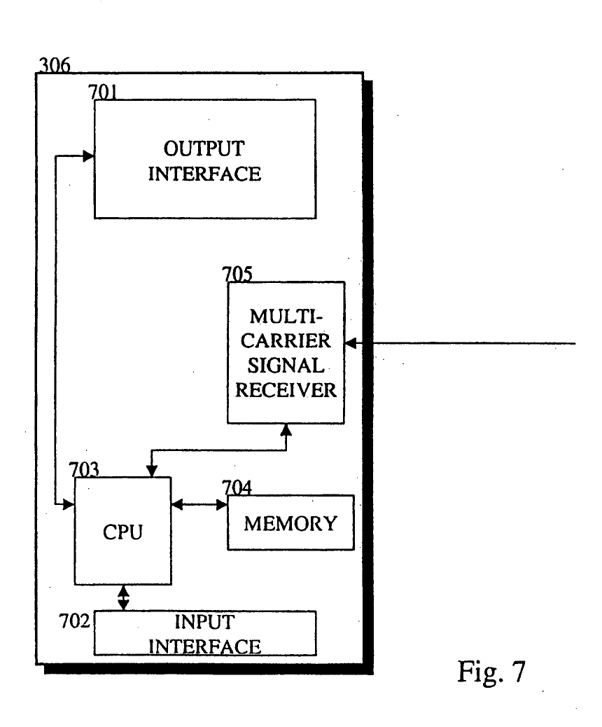

FIG. 7 has been described in the foregoing. In the following, corresponding reference signs have been applied to corresponding parts. An example of FIG. 7 depicts a functional block diagram of a receiver. The receiver 306 of FIG. 7 may be used in any/all of the example(s) of FIGS. 4, 5 and 6. The receiver 306 comprises a processing unit CPU 703, a multi-carrier signal receiver part 705 and a user interface UI (701, 702). The multi-carrier signal receiver part 705 and the user interface UI (701, 702) are coupled with the processing unit CPU 703. The user interface UI (701, 702) comprises a display and a keyboard to enable a user to use the receiver 306. In addition, the user interface UI (701, 702) comprises a microphone and a speaker for receiving and producing audio signals. The user interface UI (701, 702) may also comprise voice recognition (not shown). The processing unit CPU 703 comprises a microprocessor (not shown), memory 704 and possibly software SW (not shown). The software SW can be stored in the memory 704. The microprocessor controls, on the basis of the software SW, the operation of the receiver 306, such as the receiving of the data stream, the tolerance of the impulse burst noise in the data reception, displaying output in the user interface UI and the reading of inputs received from the user interface UI. Some operations are described in the examples of FIGS. 5 and 6. For example, the hardware (not shown) comprises means for detecting the signal, means for demodulation, means for detecting the impulse, means for blanking those samples of the symbol where significant amount of impulse noise is present, and means for calculating estimates, means for obtaining weight and carrier correction values, and means for performing the corrections of the corrupted data.

Still referring to FIG. 7, alternatively, middleware or software implementation can be applied (not shown). The receiver 306 can be a hand-held device which the user can comfortably carry. Advantageously, the receiver 306 can be a cellular mobile phone which comprises the multi-carrier signal receiver part 705 for receiving the broadcast transmission stream. Therefore, the receiver 306 may possibly interact with the service providers.

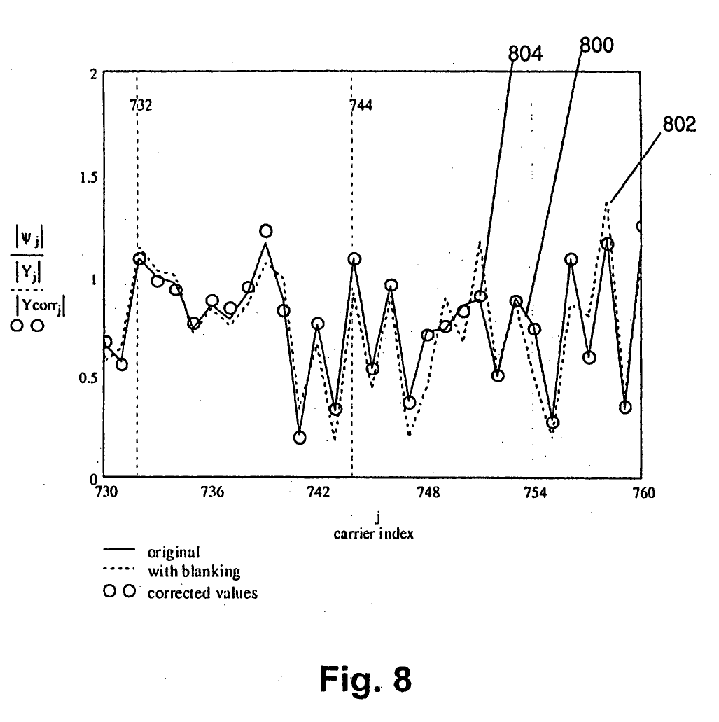

FIG. 8 shows an example of a result for a OFDM signal with 2048 carriers, where a less delayed impulse interference reduction is demonstrated in accordance with a further embodiment of the invention. Thus, the potential of the approach is demonstrated by the example with 2048 OFDM signal having pilots at intervals 12 and active carriers from 0 to 1704. The test signal has been generated using carriers with random phase and amplitude. The amplitude of the “data carriers” has been limited so that the pilot power is 16/9 times the maximum power of data carriers. The generated signal samples are blanked in the time domain (125 samples with indexes from 292 to 417). A curve 800 represents the original signal without the blanking. A dotted curve 802 represents received spectrum with the blanking. The original signal and the blanked signal in the frequency domain are shown in FIG. 8. The corrected results according to the embodied invention are given with curves with circles (804). Pilots are at indexes 732, 744, and 756. Only part of the spectrum is presented for the sake of clarity. In addition, the same figure depicts also the decoded signal according to the example. It can be noted that at least the carrier amplitudes match much better with the invention.

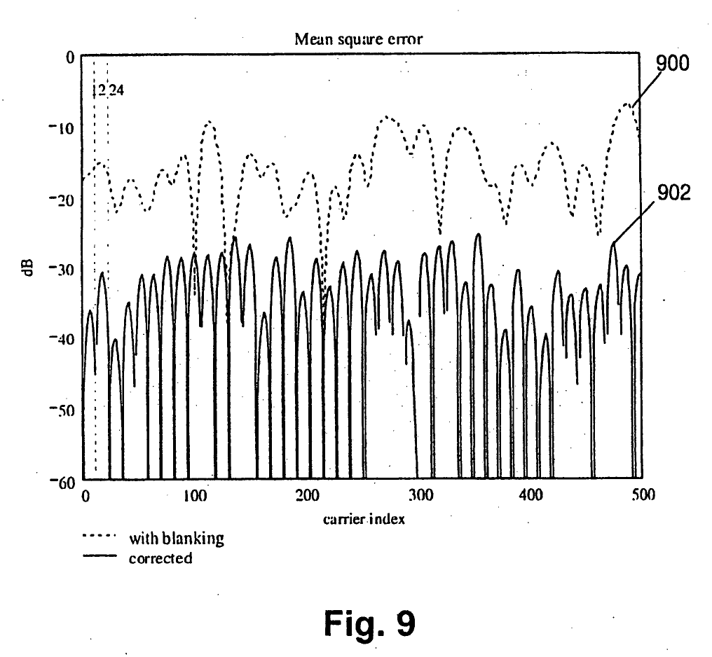

FIG. 9 shows an example of mean square errors for carriers from 0 to 500, where a less delayed impulse interference reduction is demonstrated in accordance with a further embodiment of the invention. The mean square errors apply the square absolute value of the difference of the received carrier complex value and original value on each carrier. FIG. 9 depicts these for the first 500 carriers. A curve 900 represents the result with blanking only. A curve 902 represents the correction result according to the embodied invention. One may conclude that there is at least about 10 fold difference in error power. Actually, the calculated power difference [=improvement due to the invention as compared to blanking only] for this example taken over the whole OFDM symbol is 16.4 dB and the residual error power for the corrected signal is −28.5 dB which should provide a good quality connection.

Preferably, the embodied invention provides relatively simple means to reduce high level impulse bursts provided that their length in samples is less or substantially the same order as the number of pilot carriers in the OFDM signal. For example, burst lengths is of the order of 100 μs for 8k systems and about 25 μs for 2k systems. For such lengths, the performance can be restored to the level which may be applicable at least for the most robust modulation modes. For shorter bursts, even the most sensitive modes may be applied.

Particular implementations and embodiments of the invention have been described. It is clear to a person skilled in the art that the invention is not restricted to details of the embodiments presented above, but that it can be implemented in other embodiments using equivalent means without deviating from the characteristics of the invention. The scope of the invention is only restricted by the attached claims.

1. A method for receiving a multi-carrier signal, the method comprising the steps of:
detecting a presence of at least one impulse interference within the signal,
blanking samples where significant amount of the impulse noise caused by the at least one impulse interference is present to obtain a signal with blanking,
determining an estimate of the signal with blanking,
determining carrier correction values, which carrier correction values are based on deviations of certain carrier values compared to prior known information, and the blanking, and
influencing the estimate by the carrier correction values to obtain a representation of a desired signal.

2. A method according to claim 1, wherein the step of determining the estimate comprises the step of calculating the estimate by a time domain to frequency domain transform of the signal with the blanking and temporarily storing the estimate.

3. A method according to claim 1, wherein the step of determining the carrier correction values comprises the steps of
calculating a difference between observed pilot values and known values for pilot carriers,
calculating weight values corresponding to blanking window position, and applied pilot based system,
calculating the carrier correction values based on the difference and the weight values for each carrier, and
calculating the corrected estimate by computing the carrier correction values with the stored estimate.

4. A method according to claim 1, further comprising before the step of determining the estimate, the step of shifting sampled signal in such a way that a blanking window is substantially centred at first sample position, and compensating the phase shift for each carrier before forwarding a corrected estimated signal.

5. A method according to claim 1, wherein the step of detecting is based on a sliding window calculation.

6. A method according to claim 1, wherein the step of detecting is based on monitoring an exceeding of a threshold in amplitude of the signal.

7. A method according to claim 1, preceding claims, wherein the step of detecting is based on monitoring amplitude variations.

8. A method according to claim 1, wherein the step of blanking comprises blanking a predetermined amount of digital values substantially coincident with the impulse interference.

9. A method according to claim 1, wherein the step of blanking comprises a predetermined set of blanking window positions.

10. A method according to claim 1, wherein the step of blanking comprises blanking digital values which coincide with the impulse interference.

11. A method according to claim 1, wherein the step of blanking is based on an appliance of position and duration of the impulse interference.

12. A method according to claim 1, wherein the step of blanking comprises blanking digital values directly affected by the impulse interference and digital value neighbouring the impulse interference.

13. Amended) A method according to claim 1, wherein a blanking window comprises at least one of a rectangular blanking window, and a blanking window with smooth transitions at end.

14. A method according to claim 1, wherein the carrier correction values are calculated for various carriers based on various pilot values.

15. A method according to claim 1, wherein the carrier correction values are calculated based on two closest pilots.

16. A method according to claim 15, wherein a covariance function is applied in the calculation of the carrier correction values.

17. A method according to claim 16, wherein location of a blanking window is taken in account in deriving the covariance function.

18. A method according to claim 16, wherein input samples are shifted in such a way that location of blanking window is substantially centred at first sample.

19. A method according to claim 1, wherein the certain carrier values comprises observed pilot carrier values of the received signal affected by the impulse interference.

20. Amended) A method according to claim 1, wherein the prior known information comprises previously received pilot carrier values.

21. A method according to claim 20, wherein the previously received pilot carrier values comprise transmitted pilot values multiplied with a channel estimate on pilot frequencies.

22. A method according to claim 21, wherein the previously received pilot carrier values are not affected by impulse interference.

23. A method according to claim 1, wherein the prior known information comprises interpolated pilot carrier values, wherein the interpolated pilot carrier values are obtained from a set of received OFDM symbols, wherein certain pilot carrier values affected by the impulse interference is interpolated based on pilot carrier values received before and after the certain pilot carrier values.

24. A method according to claim 23, wherein the pilot carrier values are multiplied with a channel estimate on respective pilot frequencies.

25. A method according to claim 24, wherein the before and after received pilot carrier values are not affected by impulse interference.

26. Amended) A method according to claim 3, wherein the pilot carrier values are contained in at least one OFDM symbol of the received signal.

27. A method according to claim 1, wherein the multi-carrier signal comprises OFDM signal.

28. A method according to claim 27, wherein the OFDM signal is operable in at least one of a DVB system, a terrestrial DVB system and a ISDB-T system.

29. A receiver for receiving a multi-carrier signal, the receiver comprising:
a first circuitry for detecting a presence of at least one impulse interference within the signal,
a second circuitry for blanking samples where significant amount of the impulse noise caused by the at least one impulse interference is present to obtain a signal with blanking, and for determining an estimate of the signal with blanking,
a third circuitry for determining carrier correction values, which carrier correction values are based on deviations of certain carrier values compared to prior known information, and the blanking, and
a fourth circuitry for influencing the estimate by the carrier correction values to obtain a representation of a desired signal.

30. A receiver according to claim 29, wherein the multi-carrier signal comprises OFDM signal.

31. A receiver according to claim 30, wherein the OFDM signal is operable in at least one of a DVB system, a terrestrial DVB system and an ISDB-T system.

32. A receiver according to claim 29, wherein the receiver further comprises means for interaction with a service provider providing the signal.

33. A receiver according to claim 32, wherein the means for interaction comprises a cellular mobile module operable under coverage of a cellular mobile network.

34. A receiver according to claim 29, wherein the second circuitry for determining the estimate comprises circuitry for performing a time domain to frequency domain transform of the signal with blanking.

35. A receiver according to claim 34, wherein the third circuitry for determining the carrier correction values is adapted to:
calculate a difference between observed pilot values and known values for pilot carriers,
calculate weight values corresponding to blanking window position, and applied pilot based system,
calculate the carrier correction values based on the difference and the weight values for each carrier, and
calculate the corrected estimate by computing the carrier correction values with the stored estimate.

36. A receiver according to claim 29, further comprising a broadcast multi-carrier signal receiving module.

37. A receiver according to claim 29, wherein the receiver comprises a user terminal for obtaining at least one service which is received within the signal.

38. A system for receiving a multi-carrier signal, the system comprising:
means for detecting a presence of at least one impulse interference within the signal,
means for blanking samples where significant amount of the impulse noise caused by the at least one impulse interference is present to obtain a signal with blanking,
means for determining an estimate of the signal with blanking,
means for determining carrier correction values, which carrier correction values are based on deviations of certain carrier values compared to prior known information, and the blanking, and
means for influencing the estimate by the carrier correction values to obtain a representation of a desired signal.

39. A system according to claim 38, wherein the system comprises at least one of a DVB system, a terrestrial DVB system and an ISDB-T system.

40. A computer program product comprising a program of instructions executable by a computing system for processing a reception of a broadcast multi-carrier signal, the computer program product comprising:
computer program code for causing the system to detect a presence of at least one impulse interference within the signal,
computer program code for causing the system to blank samples where significant amount of the impulse noise caused by the at least one impulse interference is present to obtain a signal with blanking,
computer program code for causing the system to determine an estimate of the signal with blanking,
computer program code causing the system to determine carrier correction values, which carrier correction values are based on deviations of certain carrier values compared to prior known information, and the blanking, and
computer program code for causing the system to influence the estimate by the carrier correction values to obtain a representation of a desired signal.

41. A method for receiving an OFDM signal, the method comprising the steps of:
detecting a presence of at least one impulse burst,
blanking samples which are affected by the at least one impulse burst,
calculating a time domain to frequency domain transform of the signal with the blanked samples to obtain an estimate,
calculating a difference between observed pilot values and known values for pilot carriers,
calculating weight values coinciding with a blanking window position,
calculating carrier correction values based on the difference and the weight values for each carrier, and
subtracting the carrier correction values from the estimate to obtain a representation of a desired signal.

42. A method according to claim 41, wherein the weight values are calculated based on the following formulae:
w=(Cₚ)⁻¹c_{b}(k), wherein w denotes the weight values, Cₚ denotes the pilot deviations, and c_{b}(k) denotes carrier index values.

43. A method according to claim 41, wherein the carrier correction values are calculated based on the following formulae:
bₖ=w^{T}P, wherein bₖ denotes the carrier correction values, w denotes the weight values, and P denotes pilot deviation values.
